(19) United States
(12) Patent Application Publication
(10) Pub. No.: US 2005/0012289 A1
(43) Pub. Date: Jan. 20, 2005

(54) Scooter usable for figure scootering

(75) Inventors: Kuo Lung Wang, Ta Li City (TW); Tuan Chang, Taichung (TW)

Correspondence Address: TROXELL LAW OFFICE PLLC, SUITE 1404, 5205 LEESBURG PIKE, FALLS CHURCH, VA, 22041, US

(73) Assignee: Valid Enterprise Co., Ltd.

(21) Appl. No.: 10/618,696

(22) Filed: Jul. 15, 2003

(51) Int. Cl. B62M 1/00

(52) U.S. Cl. 280/87.041

(57) ABSTRACT

A scooter usable for figure scootering, including: a scooter frame having a frame body for a user to step thereon; a steering mechanism disposed at a front end of the scooter frame for controlling turning direction of the scooter; a front wheel pivotally disposed at a bottom end of the steering mechanism; a rear wheel pivotally disposed under bottom face of the frame body; and an auxiliary wheel pivotally disposed under bottom face of the scooter frame behind the rear wheel. When the front and rear wheels contact with the ground, the auxiliary wheel is higher than the ground by a certain height. When the front end of the scooter is lifted, the rear wheel and the auxiliary wheel contact with the ground for performing figure scootering.

### BACKGROUND OF THE INVENTION

The present invention is related to a leisure/sport implement, and more particularly to a scooter. A user can normally use the scooter or perform figure scootering with the scooter.

A scooter can be used as a sport implement as well as a traffic tool. Many kinds of scooters have been developed with different functions. Some have different configurations and some are foldable. Also, some of the scooters are power-driven.

All the conventional scooters can be only used with the front and rear wheels contacting with the ground. It is impossible to scooter by other way. In other words, the playing manner of the scooter is unchangeable and monotonous.

### SUMMARY OF THE INVENTION

It is therefore a primary object of the present invention to provide a scooter usable for figure scootering. A user can normally use the scooter or perform figure scootering with the scooter.

The present invention can be best understood through the following description and accompanying drawings wherein:

### BRIEF DESCRIPTION OF THE DRAWINGS

FIG. 1 is a perspective assembled view of a preferred embodiment of the present invention;

FIG. 2 is a perspective exploded view of the embodiment of the present invention according to FIG. 1;

FIG. 3 is a side view showing that the scooter of FIG. 1 is used in a normal state;

FIG. 4 is a side view showing that the scooter of FIG. 1 is used in a figure state;

FIG. 5 is a sectional view of a part of another embodiment of the present invention; and

FIG. 6 is a sectional view of a part of still another embodiment of the present invention.

### DETAILED DESCRIPTION OF THE PREFERRED EMBODIMENTS

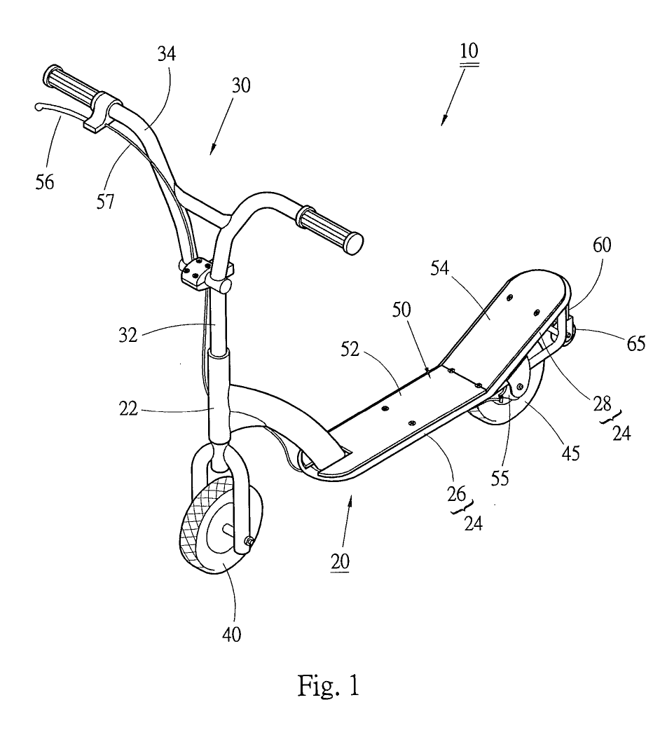

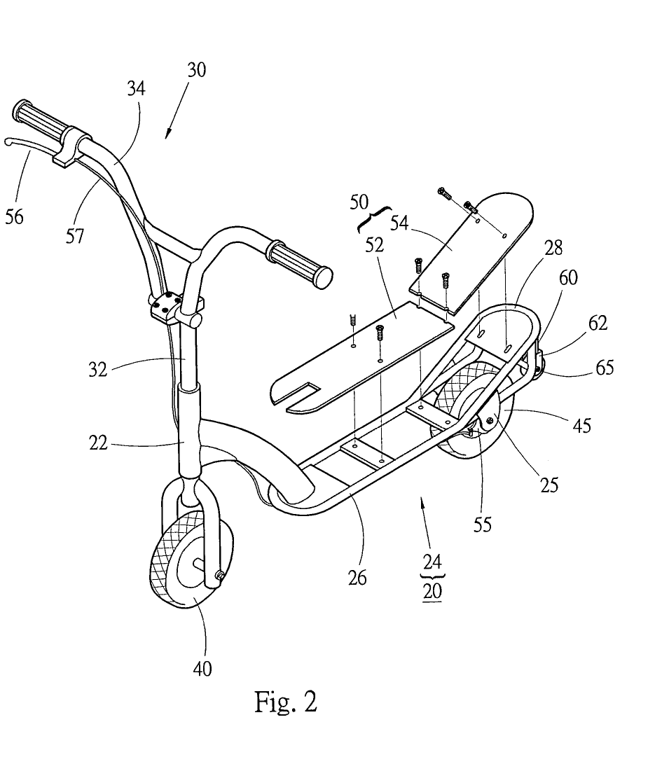

Please refer to FIGS. 1 and 2. According to a preferred embodiment, the scooter 10 of the present invention includes a scooter frame 20, a steering mechanism 30, a front and a rear wheels 40, 45, a step board 50 and a brake device 55.

The scooter frame 20 includes a front tube 22 and a frame body 24 fixedly connected with rear side of the front tube for a user to step thereon.

The steering mechanism 30 includes a vertical tube 32 and a handlebar 34. The vertical tube 32 is fitted in the front tube 22. The handlebar 34 can control the turning direction of the scooter.

The front wheel 40 is pivotally disposed between a front fork 35 mounted under bottom end of the vertical tube 32. The rear wheel 45 is pivotally disposed between a pair of lugs 25 mounted under bottom face of the frame body 24.

The step board 50 is fixedly disposed on top face of the frame body 24 for a user to step thereon.

The brake device 55 pertains to prior art and is connected with the rim of the rear wheel 45. A brake lever 56 is disposed on the handlebar 34 to via a brake cable 57 control the brake device 55 for braking the rear wheel.

The present invention is characterized in that the frame body 24 includes a plane frame section 26 and an inclined frame section 28 connected with rear side of the plane frame section. The rear end of the inclined frame section 28 is upward lifted and inclined.

The step board 50 includes two board sections respectively fixed on the top faces of the plane frame section 26 and the inclined frame section 28 by screws 51. The two board sections respectively form a plane board section 52 and an inclined board section 54.

This embodiment further includes a column 60 fixedly disposed under bottom face of the frame body 24 behind the rear wheel 45. An auxiliary wheel 65 is pivotally disposed between a pair of lugs 62 mounted at bottom end of the column 60.

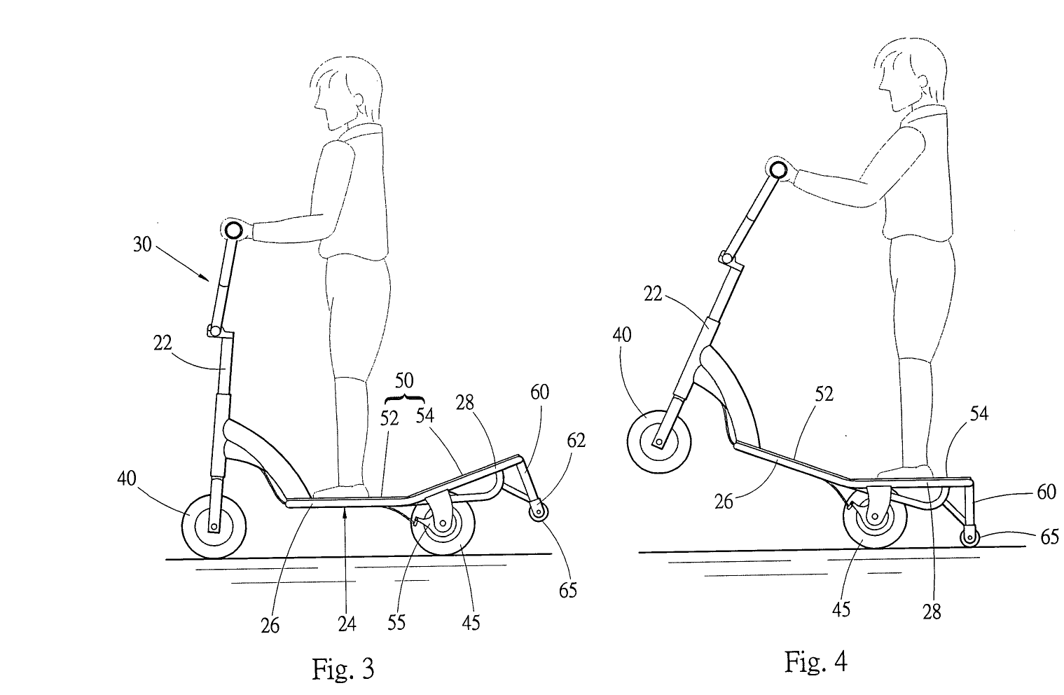

In normal use, referring to FIG. 3, the front and rear wheels 40, 45 of the scooter contact with the ground. A user steps on the plane board section 52 of the step board 50 to scooter. In the normal using state, the auxiliary wheel 65 is higher than the ground by a certain distance without touching the ground.

Referring to FIG. 4, alternatively, a user can perform figure scootering with the scooter. The user can step on the inclined board section 54 of the step board to make the front end of the scooter lifted. At this time, the front wheel 40 leaves the ground and the rear wheel 45 and the auxiliary wheel 65 contact with the ground. The inclined board section 54 is in a nearly horizontal state for the user to easily step thereon. Accordingly, with the scooter, the user can perform figure scootering.

It should be noted that in practice, the top face of the frame body can be a solid face instead of the hollow state. Therefore, a user can directly step on the frame body without adding the step board onto the frame body.

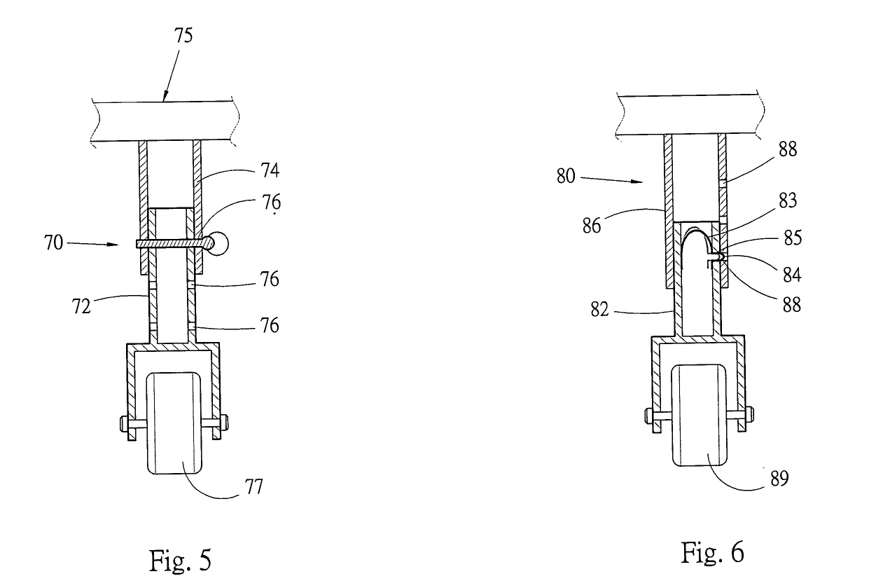

FIG. 5 shows another embodiment of the present invention, in which only the column and auxiliary wheel are shown. The other structures are identical to those of the first embodiment.

In this embodiment, the column 70 includes an inner tube 72 and an outer tube 74. The top end of the outer tube 74 is fixedly connected with bottom face of the frame body 75 and positioned behind the rear wheel. The top end of the inner tube 72 is slidably nested in the outer tube. The auxiliary wheel 77 is pivotally connected with bottom end of the inner tube. A predetermined number of through holes 76 are respectively formed on the inner and outer tubes.

An insertion pin 78 is selectively inserted in the through holes 76 of the inner and outer tubes so as to adjust the length of the inner tube protruding from the outer tube 74. In other words, the height by which the auxiliary wheel 77 is spaced from the ground is adjustable. Accordingly, when performing the figure scootering, the inclination angle of the scooter can be changed.

FIG. 6 shows still another embodiment of the present invention, in which only the column 80 is shown. A U-shaped leaf spring 83 is mounted in the inner tube 82. The leaf spring 83 has a latch section 84 at one end. The latch section 84 is fitted in a through hole 85 of the inner tube. The outer tube 86 is formed with a predetermined number of through holes 88 at equal intervals.

In normal state, the leaf spring 83 resiliently extends outward to make the latch section 84 outward extend through the through hole 85 of the inner tube and one of the through holes 88 of the outer tube 86. Therefore, the latch section 84 is latched in the through holes to locate the inner tube by a certain protruding length.

The latch section 84 can be inward pressed as shown by phantom line to make the latch section leave the through hole 88 of the outer tube. Under such circumstance, the inner tube can be freely slid to adjust the protruding length thereof. After the inner tube is adjusted to a certain position, the latch section 84 is resiliently pushed outward by the leaf spring 83 and re-latched in another through hole 88 of the outer tube. Therefore, the inner tube is located in a new position to adjust the height by which the auxiliary wheel 89 is spaced from the ground.

According to the above arrangement, the present invention provides a scooter that a user can normally use the scooter or perform figure scootering with the scooter. When performing figure scootering, the rear wheel and the auxiliary wheel can support the scooter and enable a user to easily and steadily scooter.

The above embodiments are only used to illustrate the present invention, not intended to limit the scope thereof.

1. A scooter usable for figure scootering, comprising:
a scooter frame including a frame body for a user to step thereon, the frame body including a plane frame section and an inclined frame section connected with rear side of the plane frame section, a rear end of the inclined frame section being upward inclined;
a steering mechanism including a vertical tube and a handlebar disposed at a top end of the vertical tube, the steering mechanism being disposed at a front end of the scooter frame;
a front wheel pivotally disposed at a bottom end of the steering mechanism;
a rear wheel pivotally disposed under bottom face of the frame body; and
an auxiliary wheel pivotally disposed under bottom face of the scooter frame behind the rear wheel, when the front and rear wheels contact with the ground, the auxiliary wheel being higher than the ground by a certain height, whereby when the front end of the scooter is lifted, the rear wheel and the auxiliary wheel contact with the ground for performing figure scootering, the inclined frame section being in a nearly horizontal state.

2. The scooter as claimed in claim 1, wherein a column is fixedly disposed under bottom face of the frame body behind the rear wheel, the auxiliary wheel being pivotally disposed at bottom end of the column.

3. The scooter as claimed in claim 2, wherein the column includes an inner tube and an outer tube, a top end of the outer tube being fixedly connected with bottom face of the frame body, a top end of the inner tube being slidably nested in the outer tube, a bottom end of the inner tube protruding from the outer tube, the length of the inner tube protruding from the outer tube being adjustable, the auxiliary wheel being pivotally connected with bottom end of the inner tube.

4. The scooter as claimed in claim 3, wherein a predetermined number of through holes are respectively formed on the inner and outer tubes, an insertion pin being selectively inserted in the through holes of the inner and outer tubes.

5. The scooter as claimed in claim 3, wherein the inner tube is formed with a through hole and the outer tube is formed with a predetermined number of through holes at intervals, a resilient member being mounted in the inner tube, a latch section being connected with the resilient member and positioned in the through hole of the inner tube, wherein in normal state, the resilient member resiliently pushes the latch section outward to make the latch section latched in one of the through holes of the outer tube.

6. The scooter as claimed in claim 1, further comprising a step board being disposed on top face of the frame body.

7. The scooter as claimed in claim 6, wherein the step board including a plane board section and an inclined board section, the plane board section being disposed on top face of the plane frame section, while the inclined board section being disposed on top face of the inclined frame section.

8. The scooter as claimed in claim 1, further comprising a brake device connected with the rear wheel, a brake lever disposed on the handlebar and a brake cable connected between the brake device and the brake lever.

9. A scooter usable for figure scootering, comprising:
a scooter frame including a frame body for a user to step thereon;
a step board disposed on top face of the frame body, the step board including a plane board section and an inclined board section connected with rear side of the plane board section, a rear end of the inclined board section being upward inclined;
a steering mechanism including a vertical tube and a handlebar disposed at a top end of the vertical tube, the steering mechanism being disposed at a front end of the scooter frame;
a front wheel pivotally disposed at a bottom end of the steering mechanism;
a rear wheel pivotally disposed under bottom face of the frame body; and
an auxiliary wheel pivotally disposed under bottom face of the scooter frame behind the rear wheel, when the front and rear wheels contact with the ground, the auxiliary wheel being higher than the ground by a certain height, whereby when the front end of the scooter is lifted, the rear wheel and the auxiliary wheel contact with the ground for performing figure scootering, the inclined board section being in a nearly horizontal state.

10. The scooter as claimed in claim 9, wherein a column is fixedly disposed under bottom face of the frame body behind the rear wheel, the auxiliary wheel being pivotally disposed at bottom end of the column.

11. The scooter as claimed in claim 10, wherein the column includes an inner tube and an outer tube, a top end of the outer tube being fixedly connected with bottom face of the frame body, a top end of the inner tube being slidably nested in the outer tube, a bottom end of the inner tube protruding from the outer tube, the length of the inner tube protruding from the outer tube being adjustable, the auxiliary wheel being pivotally connected with bottom end of the inner tube.

12. The scooter as claimed in claim 11, wherein a predetermined number of through holes are respectively formed on the inner and outer tubes, an insertion pin being selectively inserted in the through holes of the inner and outer tubes.

13. The scooter as claimed in claim 11, wherein the inner tube is formed with a through hole and the outer tube is formed with a predetermined number of through holes at intervals, a resilient member being mounted in the inner tube, a latch section being connected with the resilient member and positioned in the through hole of the inner tube, wherein in normal state, the resilient member resiliently pushes the latch section outward to make the latch section latched in one of the through holes of the outer tube.

14. The scooter as claimed in claim 9, further comprising a brake device connected with the rear wheel, a brake lever disposed on the handlebar and a brake cable connected between the brake device and the brake lever.
